(19) United States
(12) Patent Application Publication
(10) Pub. No.: US 2010/0051109 A1
(43) Pub. Date: Mar. 4, 2010

(54) CO2 dialer and manifold apparatus and system

(76) Inventor: Michael Meier, Miliwaukee, WI (US)

Correspondence Address: RYAN KROMHOLZ & MANION, S.C., POST OFFICE BOX 26618, MILWAUKEE, WI, 53226, US

(21) Appl. No.: 12/584,297

(22) Filed: Sep. 3, 2009

Related U.S. Application Data
(60) Provisional application No. 61/208,522, filed on Feb. 25, 2009.
(60) Provisional application No. 61/190,953, filed on Sep. 4, 2008.

(51) Int. Cl. F17D 1/00

(52) U.S. Cl. 137/1; 137/572

(57) ABSTRACT

A system and method for notifying a supplier of gas when a system has changed from a first gas tank to a second gas tank. The system includes a selecting valve, an initiating apparatus, and a calling apparatus. The initiating apparatus is coupled to a selecting valve which is coupled to at least two gas tanks. When the selecting valve moves from the first tank to the second tank the initiating apparatus is activated which initiates the calling apparatus. The calling apparatus notifies a gas supplier or a third party that the user has switched from a first gas tank to a second gas tank allowing the supplier to know when to deliver a replacement gas tank or refill the existing gas tank.

### RELATED APPLICATIONS

This application claims the benefit of U.S. Provisional Patent Application Ser. No. 61/208,522, filed 25 Feb. 2009, and entitled “Successive Multi-Cylinder Manifold” and also claims the benefit of U.S. Provisional Patent Application Ser. No. 61/190,953, filed 4 Sep. 2008, and entitled “CO2 Dialer.”

### BACKGROUND OF THE INVENTION

Bulk beverages, such as beers and ciders are often supplied in kegs and served with external pressure. This external pressure generally comes from a cylinder of gas such as carbon dioxide or nitrogen. The gas forces the beer out of the keg and into a tube which leads to a tap. The beverage is then dispensed from the tap. The tap is generally opened by pressing a lever.

Many bars, restaurants, sports facilities, social clubs, and other public and private facilities utilize such gas tanks to pressurize bulk beer in kegs for service. Often these facilities have more than one gas tank. The two gas tanks are often connected to a switch such that when one gas tank is emptied, the switch can be flipped and the second tank may be used.

Facilities will often contract with a gas provider to replace and refill their gas tanks. Generally someone at the facility will contact their gas provider when they switch from one supply tank to the other. In this manner the gas provided will know when to provide gas to the facility. However, often the owners or staff of the facility will forget to contact the gas provider.

### BRIEF DESCRIPTION OF THE DRAWINGS

FIG. 1 is a schematic of a system according to the present invention.

FIG. 2 is schematic of an alternative embodiment of a system according to the present invention.

FIG. 3 is schematic of an alternative embodiment of a system according to the present invention.

FIG. 4 is schematic of an alternative embodiment of a system according to the present invention.

FIG. 5 is schematic of an alternative embodiment of a system according to the present invention.

FIG. 6 is a schematic of the embodiment of FIG. 5 utilizing multiple initiating apparatus.

FIG. 7 is schematic of an alternative embodiment of a system according to the present invention.

FIG. 8 is a schematic of the control system of the embodiment of FIG. 7.

FIG. 9 is a schematic of an alternative embodiment of a system according to the present invention.

FIG. 10 is a of the control system of the embodiment of FIG. 9.

FIG. 11 is a schematic of an embodiment of a manifold utilizing one regulator unit according to the present invention.

FIG. 12 is a schematic of an embodiment of a manifold utilizing multiple regulator units according the present invention

FIG. 13 is a schematic of the manifold of FIG. 12 in use on tanks.

### SUMMARY OF THE INVENTION

The present invention provides systems and methods for switching between gas tanks and notifying a party that a gas tank is empty or near empty.

One aspect of the invention provides a system including a first gas tank and a second gas tank, each of said gas tanks having a fluid outlet, a first regulator having an inlet and an outlet, the first regulator inlet being coupled to the outlet of the second gas tank and the first regulator outlet being coupled to the outlet of the first gas tank and the beverage dispensing system; and a first check valve disposed between the output of the first regulator and output of the first gas tank.

The system may include at least one regulator including a pressure gauge.

The system may include the first regulator and the first check valve being integrally formed.

The system may include an initiating apparatus coupled to the outlet of the first tank and the outlet of the first regulator and a calling apparatus in electronic communication with the initiating apparatus.

The system may include the initiating apparatus including a first high pressure switch in fluid communication with the output of the first tank and the outlet of the first regulator.

The system may include the initialing apparatus being a trigger coupled to the first high pressure switch, the trigger being in communication with the calling apparatus.

Another aspect of the invention provides a system including at least two gas tanks, each of said gas tanks having a fluid outlet, a selecting valve, the selecting valve having an inlet coupled to the outlet of the second gas tank and an output coupled to a beverage distributing system, an initiating apparatus coupled to the selecting valve, and a calling apparatus in electronic communication with the initiating apparatus.

The system may include the calling apparatus being a dialing apparatus.

The system may include the selecting valve being a manual selecting valve.

The system may include the selecting valve being an automatic selecting valve.

The system may include a pressure switch in electronic communication with the automatic selecting valve.

The system may include a third gas tank having a fluid outlet and an auxiliary selecting valve, the auxiliary selecting valve having an inlet coupled to the outlet of the third gas tank and an inlet coupled to the beverage distributing system.

The system may include the auxiliary selecting valve having a normally closed configuration.

The system may include the valve including a second inlet coupled to the outlet of the first gas tank

The system may include a third gas tank having a fluid outlet, a second selecting valve, the second selecting valve having an inlet coupled to the outlet of the third gas tank and an outlet coupled to the beverage distributing system, and a second initiating apparatus coupled to the outlet of the second gas tank.

Another aspect of the invention provides a method including providing a system including at least two gas tanks, each of said gas tanks having a fluid outlet, at least one selecting valve having an inlet coupled to the outlet of the second gas tank and a output coupled to a beverage distributing system, an initiating apparatus coupled to the selecting valve, and a calling apparatus in electronic communication with the initiating apparatus, sensing when the pressure of the gas leaving the first gas tank reaches a predetermined pressure, and switching from the first gas tank to the second gas tank.

### Description of the Preferred Embodiment

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

The present invention is a system and method for notifying a party that a system has changed from a first gas tank 12 to a second gas tank 14 for use in a beverage distributing system 16. The system includes preferably includes an initiating apparatus 18 coupled to a selecting valve 20 and a calling apparatus 22.

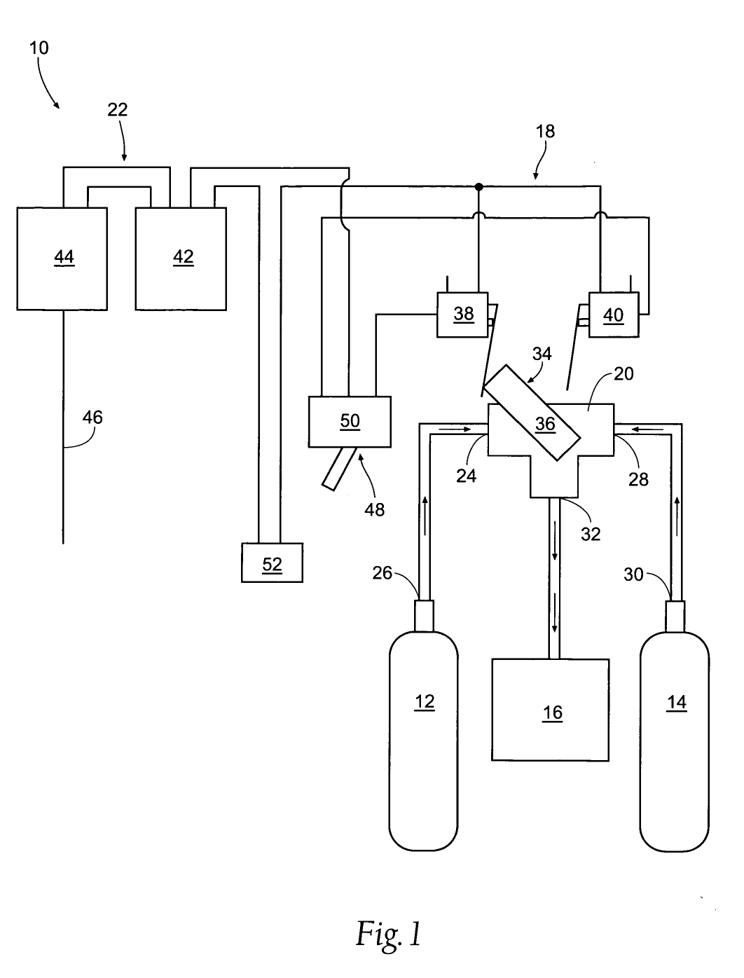

The selecting valve 20 may be of any type known in the art. The selecting valve 20 in the illustrated embodiment shown in FIG. 1 is a three-way valve. The first input 24 is coupled to the output 26 of a first gas tank 12. The second input 28 is coupled to the output 30 of the second gas tank 14. The output 32 is coupled to the beverage distributing system 16. The selecting valve 20 has a first open position wherein fluid may flow from the first input 24 to the output 32 and a second open position wherein fluid may flow from the second input 28 to the output 32.

The selecting valve 20 preferably includes selecting means 34 for switching the valve 20 between the first open position and the second open position. In the illustrated embodiment of FIG. 1, the selecting means 34 for is a handle 36. The handle 36 is movable between a first position wherein the valve 20 is in its first open position and a second position wherein the valve 20 is in its second open position. It should be understood that when the handle 36 is at the first position gas may flow from the first tank 12 to the beverage distributing system 16. Likewise, when the handle 36 is in the second position gas may flow from the second tank 14 to the beverage distributing system 16.

In the illustrated embodiment the initiating means 18 comprises the selecting means 34 on the selecting valve 20 and a pair of switches 38,40. The first tank switch 38 is configured such that when the selecting means 34 is in the first position the first tank switch 38 is closed. The second tank switch 40 is configured such that when the selecting means 34 is in the second position the second tank switch 40 is open.

As can be seen in FIG. 1, when the first tank switch 38 is closed, a circuit between the calling apparatus 22 and the initiating apparatus 18 is completed. This causes the calling apparatus 22 to be engaged.

In the illustrated embodiment the calling apparatus 22 comprises a repeat cycle timer 42 and a one-button dialer 44. When the calling apparatus 22 is engaged the repeat cycle timer 42 causes the one-button dialer 44 to make a call at a predetermined interval.

It is further contemplated that the system 10 may include a reset element 48. In the illustrated embodiment of FIG. 1 the reset element 48 takes the form of a toggle switch 50. The toggle switch 50 preferable has a first position and a second position. In use, the toggle switch 50 is in its first position when the first gas tank 12 is in use. When the selecting valve 20 is moved from its first position to its second position, a circuit, including the reset element 48, is completed. When the first gas tank 12 is replaced the reset element 50 may be moved from the first position to the second position. This interrupts the circuit. In this manner no power is being supplied to the calling apparatus 22. In the same manner, then the selecting valve 20 is moved from the second position back to the first position, a circuit is again completed initiating the calling apparatus 22.

The calling apparatus 22 of the illustrated embodiment is preferably coupled to a phone line 46. However, it is also contemplated that any other communication means known in the art could be utilized. For example, and not by way of limitation, a cellular calling device could be utilized.

The system 10 preferably includes a power source 52. The power source 52 may take any form known in the art. It is contemplated that the power source 52 may take the form of at least one battery. It is further contemplated that the power source 52 may take the form of the electrical system of the building and the system may be plugged into an electrical outlet or hard-wired into the building.

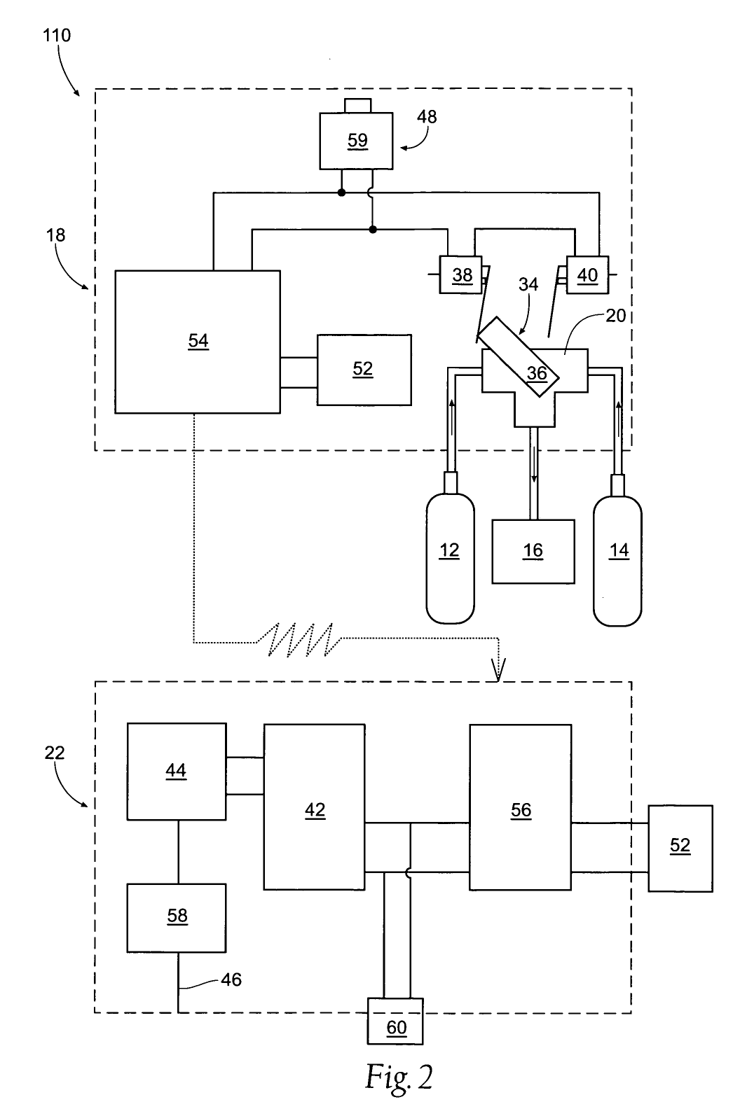

In an alternative embodiment the system 110 may be wireless. In particular, the communication between the initiating apparatus 18 and the calling apparatus 22 may be wireless as shown in FIG. 2. As described above, it should be understood that when the handle 36 is at the first position gas may flow from the first tank 12 to the beverage distributing system 16. Likewise, when the handle 36 is in the second position gas may flow from the second tank 14 to the beverage distributing system 16. However, in the illustrated embodiment a circuit is completed within the initiating apparatus 18 when the selecting means 34 on the selecting valve 20 is between the first tank switch 38 and the second tank switch 40. The completion of this circuit initiates a remote 54 to send a signal to a receiver 56 associated with the calling apparatus 22. When the received 56 received a signal the calling apparatus 22 is engaged which causes the repeat cycle timer 42 to engage the one-button dialer 44 to make a call at a predetermined interval. The system 110 may include reset means 48 comprise a button 59 on the initiating apparatus 18. It is contemplated that both the initiating means 18 and the calling apparatus 22 may be connected to a power source 52 as is known in the art. It is contemplated that the system 110 may include an indicator 60 which would indicate whether or not the calling apparatus is engaged.

It is contemplated that the calling apparatus 22 could contact the supplier of gas. In this manner the gas supplier would be informed that the customer has switched from one tank to the other and that another tank of gas should be supplied to the customer. It is further contemplated that the calling apparatus 22 could contact a third party. The third party could then contact the gas supplier. In this manner a single third party could receive the calls for a plurality of gas suppliers, and inform each gas supplier when a customer's gas tank should be replaced.

It should be understood that more than two gas tanks 12,14 may be connected. It is contemplated that an alternative selecting valve 20 may be utilized which may have additional inputs. For example, if three gas tanks are utilized a four-way valve may be utilized as a selecting valve 20.

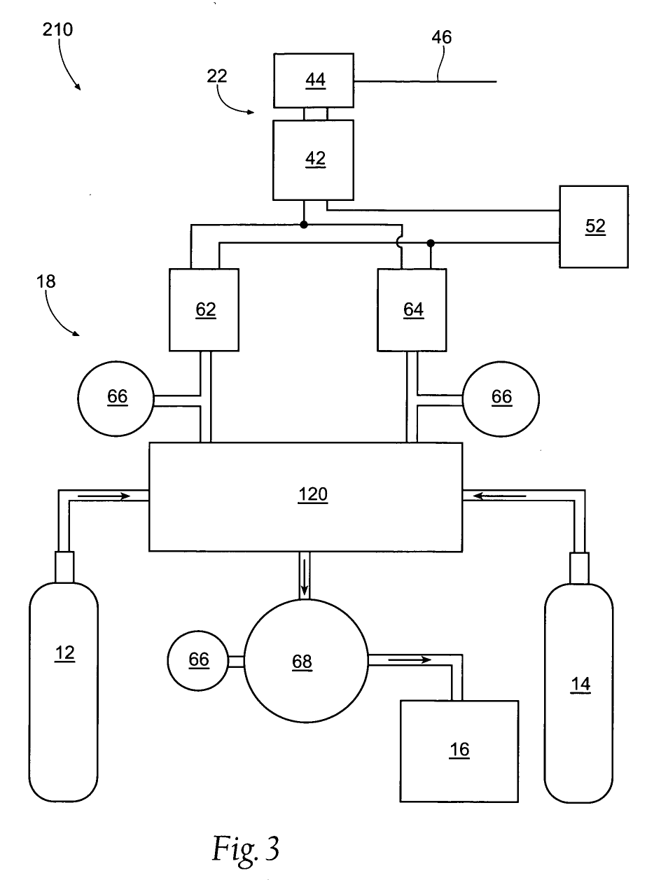

It is further contemplated that the selecting valve 20 could be an automatic selecting valve 120 as shown in FIG. 3. In such an automatic selecting valve 120, a pressure sensor associated with the valve 120 determines when the pressure in a tank 12,14 reaches a predetermined value. The automatic selecting valve 120 then automatically switches to the other tank 12,14. In the illustrated embodiment the initiating means 18 comprises a pair of high pressure switches 62,64. When the pressure falls below a predetermined valve the circuit between the initiating means 18 and the calling means 22 is completed. Completing the circuit turns on the repeat cycle timer 42 which in turn engages the dialer 44. As described above, the system 210 is preferably connected to a power source 52 as is known in the art. It is contemplated that the system 210 may have a plurality of pressure gauges 66 and a regulator 68 associated with the system 210.

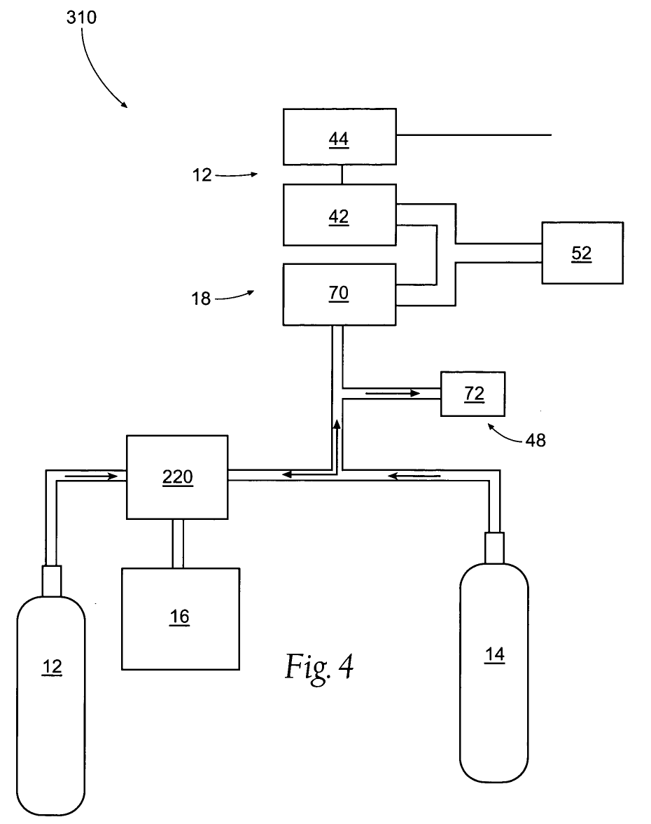

An alternative embodiment of the system 310 is in shown in FIG. 4. The selecting means may take the form of a selecting valve 20. The selecting valve 20 may be an automatic selecting valve 120 as described above or a manual selecting valve. The initiating apparatus 18 preferable includes a single pressure switch 70. It is contemplated that the second gas tank 14 the embodiment of FIG. 4 may be generally closed and when the selecting valve 220 is moved to the tank two position the second tank 14 could be opened. This causes gas to flow from the second tank 14 to the beverage distribution system 16. When the pressure in the system reaches a predetermined level the pressure switch 70 closes the circuit between the initiating apparatus 18 and the calling apparatus 22. The closing of the circuit between the initiating apparatus 18 and the calling apparatus 22 engages the calling apparatus 22. Completing the circuit turns on the repeat cycle timer 42 which in turn engages the dialer 44. As described above, the system 210 is preferably connected to a power source 52 as is known in the art. The system preferably includes a reset means 48. The reset means 48 of the illustrated embodiment takes the form of an air cock 72. When the air cock 72 is opened the air pressure in the lines is reduced, and the pressure switch 70 causes the circuit to open and the calling apparatus 22 is disengaged.

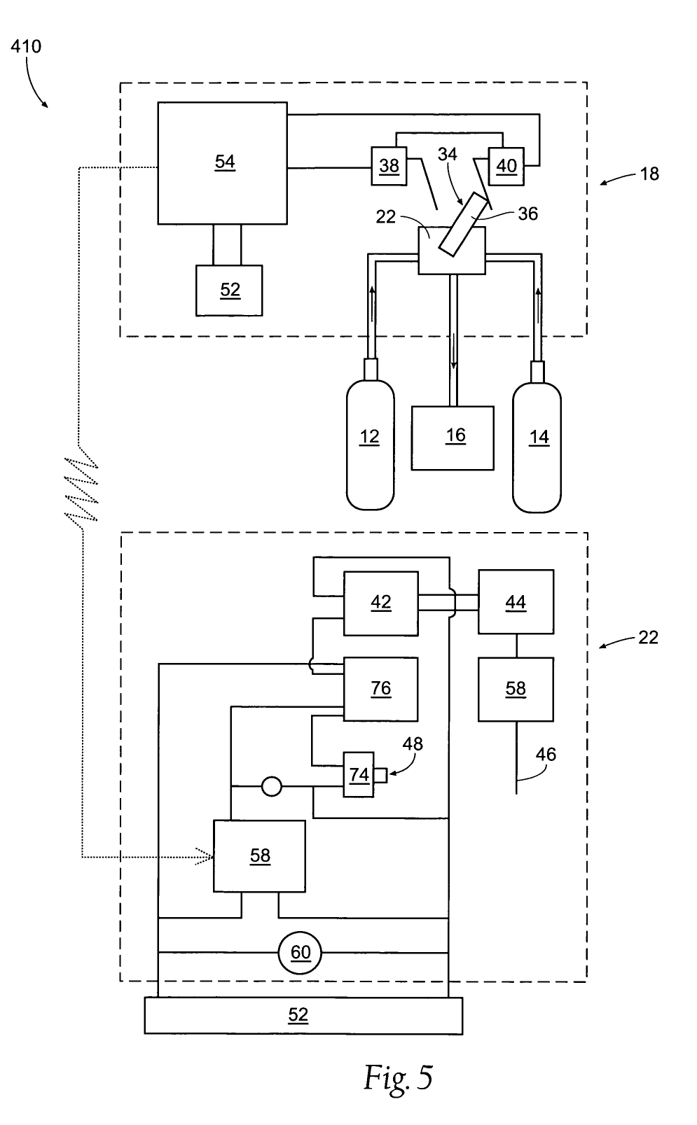

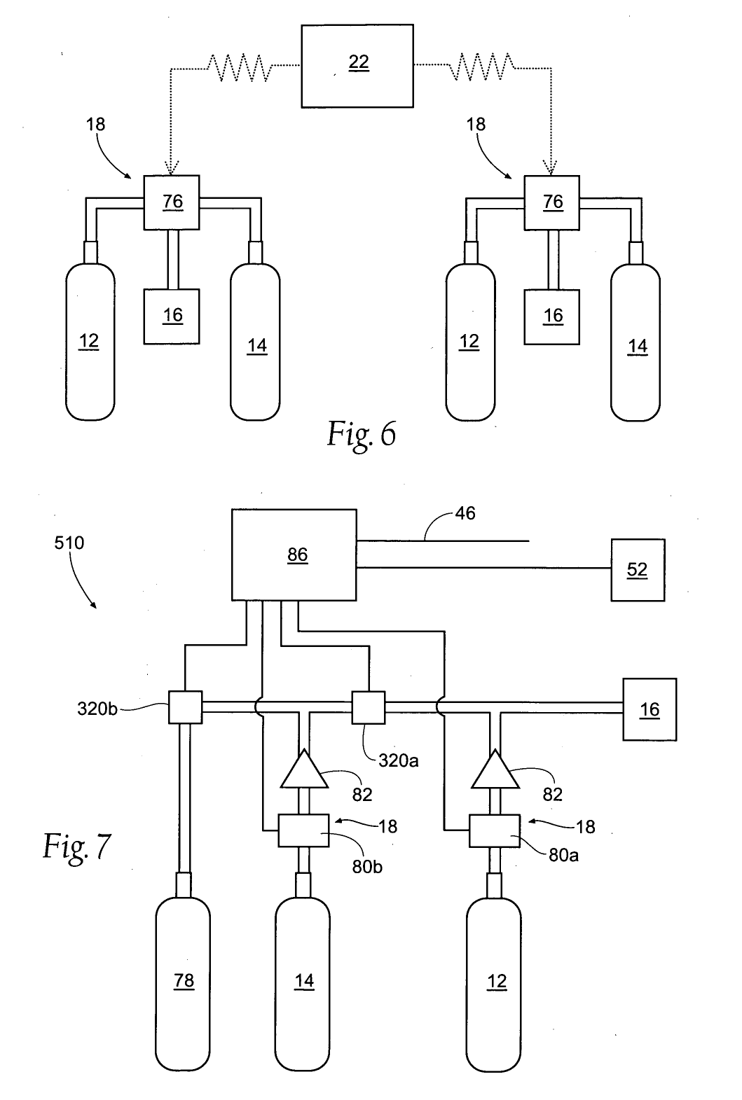

It is further contemplated that a single calling apparatus 22 could be utilized with multiple initiating apparatuses 18 as shown in FIG. 5 and FIG. 6. In use, a user may use the selecting means 34 to switch the selecting valve 22 from the first tank position where gas is supplied from the first tank 12 to the second tank position where gas is supplied by the second tank 14. In the illustrated embodiment a circuit is completed within each initiating apparatus 18 when the selecting means is between the first tank switch 38 and the second tank switch 40. The completion of this circuit sends a signal from a transmitter 54 associated with the initiating apparatus 18 to a receiver 56 associated with the calling apparatus 22 which in turn activates the calling apparatus 22.

The single receiver 56 associated with the calling apparatus 22 is adapted to receive signals from multiple initiating devices 18. The system preferably includes a reset element 48 which may take the form of a reset button 74. The calling apparatus 22 preferably remains activated until the system is reset by the reset element 48. In this manner, even if additional signals are received by the receiver 56, the calling apparatus 22 will remain activated until reset. It is contemplated that the selecting valve 20 and the initiating means 18 may be formed in a single box 76 as shown in FIG. 6. It is further contemplated that the calling apparatus 22 circuit may include a relay 76.

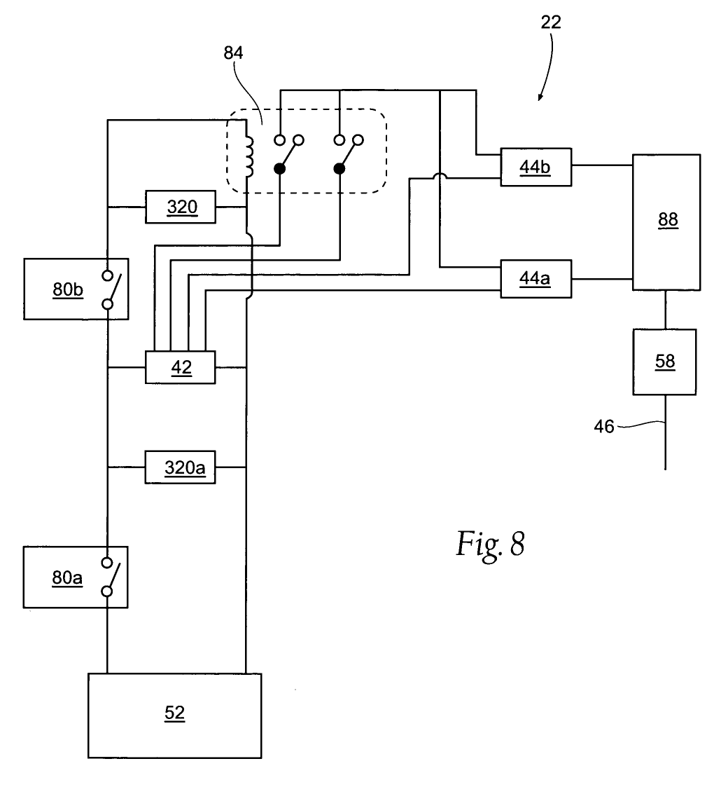

It is further contemplated that the system could include more than two gas tanks and could also utilize automated selecting means as shown in FIG. 7 and FIG. 8. The illustrated embodiment of FIG. 7 includes a plurality of gas tanks 12,14,78 each of which is connected to the beverage distributing system 16. All but the last gas tank is associated with an initiating apparatus 18 and a selecting valve 320 as shown in FIG. 7. It is contemplated that the selecting valve 320 may comprise a normally closed solenoid valve. In the illustrated embodiment the initiating apparatus 18 takes the form of a pressure-sensing switch 80. Preferably, a check valve 82 is in association with each gas tank 12,14,78 to prevent gas from entering the gas tanks 12,14,78.

The pressure-sensing switch 80 is designed to close to complete a circuit when the pressure reaches to a certain predetermined level. For example, when pressure sensing switch 80a which is in association with tank 12 senses a predetermined pressure in the gas line, the associated selecting valve 320a is engaged and opens. This allows gas will be provided to the beverage distributing system 16 from the next gas tank in line, the second tank 14. Preferably, a check valve 82 is in association with each gas tank 12,14,78 to prevent gas from entering the gas tanks 12,14,78. When initiating apparatus 18 is activated, the circuit is energized which engages the calling apparatus 22. In the illustrated embodiment the calling apparatus 22 takes the form of a repeat cycle timer 42 coupled to a pair of dialers 44 including a module 88 to combine the lines. However, it should be noted that a single dialer 44 could be utilized. At predetermined intervals the repeat cycle timer 42 engages a dialer 44a to dial a predetermined number. It is contemplated that the calling apparatus 22 may be located in a control box 86 as shown in FIG. 7.

When the pressure in the second tank 14 falls below the predetermined level the second pressure sensing switch 80b closes which energizes the second solenoid valve 320b. In the illustrated embodiment a relay 84 is associated with the second solenoid valve 320b such that energizing of the second solenoid valve 320b energizes the relay 84 which switches from a first dialer 44a to a second dialer 44b. The repeat cycle timer 42 then engages the second dialer 44b at predetermined intervals and the second dialer 44b dials a predetermined number.

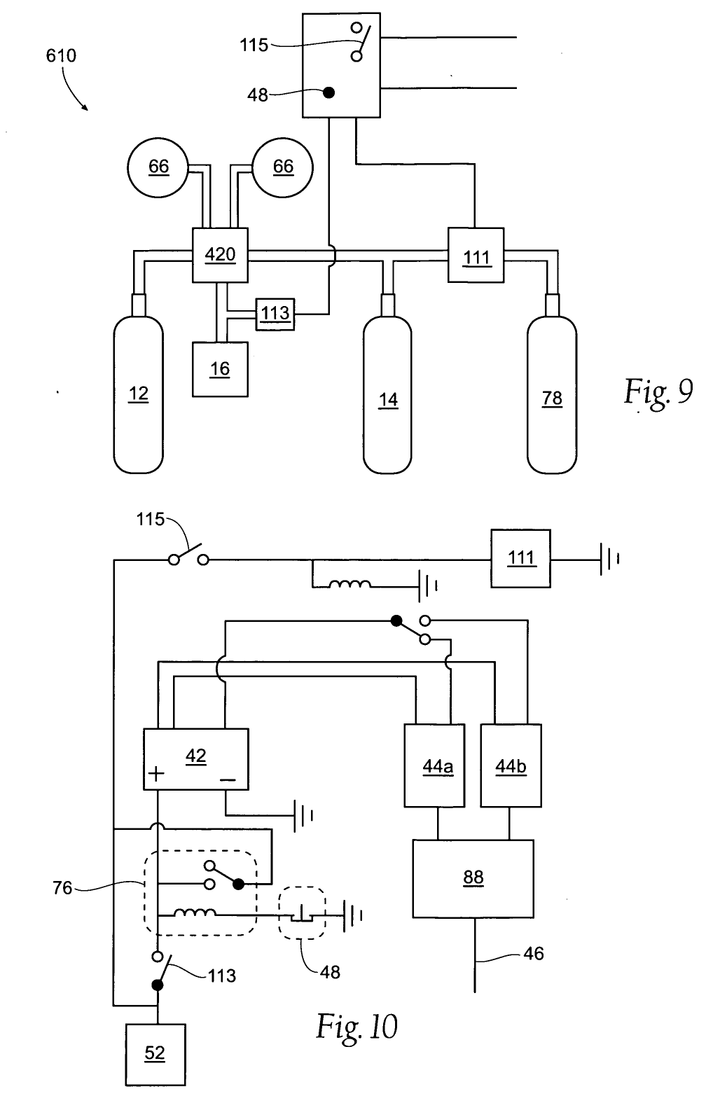

It is further contemplated that the system could include a pair of supply tanks 12,14 with an automatic selecting valve 420 disposed between the two and an auxiliary tank 78 which is manually engaged as shown in FIGS. 9 and 10. In such an automatic selecting valve 420, a pressure sensor associated with the valve 420 determines when the pressure in a first tank 12,14 reaches a predetermined value. The automatic selecting valve 420 then automatically switches to the other tank 12,14. The system preferably includes a control box 86. The calling apparatus may be disposed within the control box 86. A switch 113 associated with the system detects when the pressure in the line reaches a predetermined level. When the pressure reaches that predetermined level the circuit closes which activates the calling apparatus. The system may include a pair of dialing apparatuses. When the switch 113 closes the circuit, the calling apparatus activates the first dialing apparatus 44a. The first dialing apparatus 44a may be disengaged by engaging a reset means 48 associated with the system. The circuit may include a relay 76.

An auxiliary selecting valve 111 may is preferably normally closed and is opened after a manually engaged. For example, in the illustrated embodiment the auxiliary selecting valve 111 is a normally closed solenoid valve. When a switch 115 at the control box is turned on, the solenoid valve is energize and is opened. Turning the switch on also activates the second dialing apparatus 44b.

The system may also include a power source 52 coupled to the control box. In this manner, there is a leak in the system, attention will be drawn to the system before all three tanks are empty.

It is contemplated that the information transmitted by the system 10,110,210,310,410,510,610 could be of any type including, but not limited to voice, data, or text. In this manner, the system 10,110,210,310,410,510,610 may communicate with a telephone, a paging device, a computer, a PDA. It is further contemplated that the information could be sent to a computing system which would upload the data to a website. In this manner, a gas supplier could check a website to determine which customers require a gas tank. It is further contemplated that the calling apparatus 22 may include an on-hook detection apparatus 58 as shown in FIG. 2. In this manner if the phone line 46 is already in use, the dialer 44 will not be able to make a call.

It is contemplated that the components that make up the calling apparatus 22 and the initiating apparatus 18 may either be built into a single box or that the components could be separately installed. Further, although the illustrated embodiment is directly coupled to the selecting valve 20, it is contemplated that the initiating device 18 and calling device 22 could be either directly or indirectly coupled to the selecting valve 20.

It should be understood that although the calling apparatus 22 is shown as including a repeat cycle timer and a dialing apparatus, it is further contemplated that the calling apparatus could take any form known in the art. For example, the calling apparatus may take the form of a commercially provided device. Such a device may include an E-sentinel™ as provided by Telsoft, Inc. of Boise, Id. The E-sentinel™ is adapted to detect at least one predetermined event, such as the closing of a circuit, and dial a preprogrammed number in response to the event. The E-sentinel™ may be adapted to leave one of two numeric messages depending on the event which was detected.

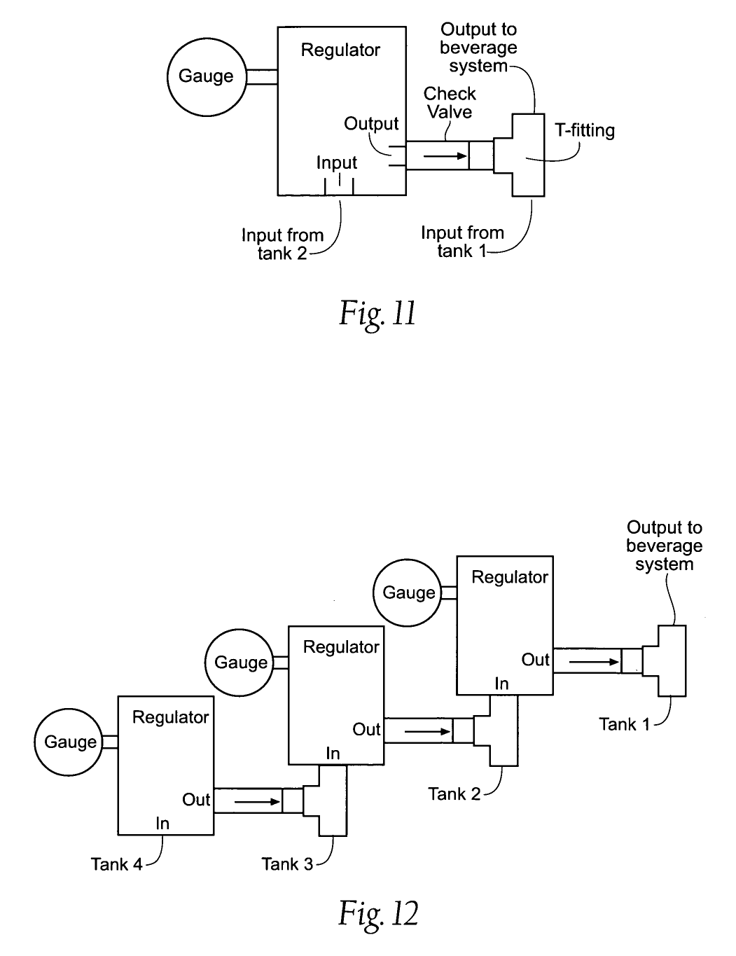

FIGS. 11 through 13 show an embodiment of a successive multi-cylinder manifold. This is similar to the system of FIG. 7, however, it may be adapted to utilize regulators rather than solenoid valves. The system includes at least two tanks and at least one regulator unit. As shown in FIG. 11, each regulator unit preferably includes a regulator having an input and an output and at least one check valve. The at least one check valve is preferably located at the output of the regulator. As shown in FIG. 12, it is contemplated that multiple regulator units may be combined in succession if desired. Although FIG. 12 shows the use of three regulator units, it is contemplated that any number of regulator units may be utilized.

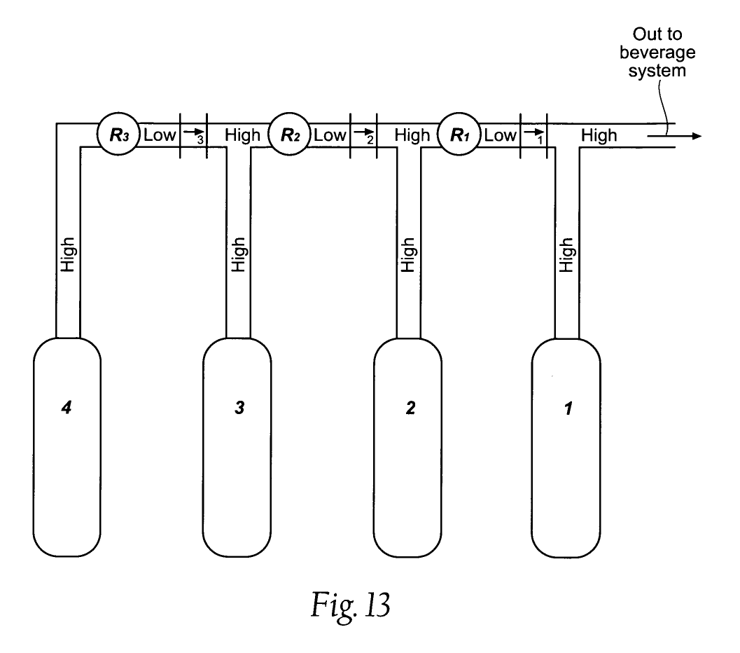

The illustrated embodiment of FIG. 13 utilizes four tanks and three regulator units. In use, gas will flow out of tank 1 because the pressure behind the check valve is at a predetermined low value, for example 300 psi, due to regulator 1. Gas will continue to flow out of tank 1 until the pressure in that tank reaches the predetermined low value. At that point gas from tank 2 will flow to the system because the pressure in front of the check valve is equal to the pressure behind it. The tanks will continue to be drawn in a successive manner until the pressure in all four tanks reaches the predetermined low value. At that point the remaining gas in the four tanks will be drawn on equally until the tanks are completely empty or any or all of the tanks are refilled or replaced with full tanks. It should be understood that gas will always be drawn out of the tanks that is closest to the beverage system output and has a pressure above the predetermined low value.

As shown in FIG. 11, the input from of the regulator is preferably coupled to the output of tank 2. The output of the regulator is preferably coupled to the output of tank one and the beverage dispensing system. In the illustrated embodiment this is achieved by a t-fitting, however it is completed any means known in the art. A check valve is preferably located between the output of the regulator and the t-fitting. In this manner, gas is prevented from flowing from tank one to tank two.

It should be understood that when multiple regulator units are utilized, each regulator unit is placed between a pair of tanks, and thus is adjacent to two tanks. It should further be understood that the output of each regulator is coupled to the output of the adjacent tank which is closest to the beverage system while the input of each regulator is coupled to the output of the adjacent tank which is furthest from the beverage system.

It is contemplated that, if desired, each regulator unit may include a gauge. Although the illustrated embodiment shows the use of four tanks, it is contemplated that any number of tanks may be utilized.

It should be understood that the regulator unit may be made as a single piece if desired. Alternatively, the regulator and check valve may be separately provided and coupled using standard joining techniques known in the art.

It is contemplated that if desired, a system using a manifold with at least one regulator unit as shown in FIGS. 11 through 13 may be coupled to a calling apparatus. The calling apparatus may take any form, including the embodiments described above. Preferably, at least one initiating apparatus is coupled to the manifold. The initiating apparatus is adapted to initiate the calling apparatus. In this manner, the system may be set up to notify a gas provider, or a third party, when a predetermined tank has reached the predetermined low value. It is further contemplated that the system may include multiple initiating apparatus.

It should be understood that the manifold may be adapted to work with any number of tanks by adding a regulator unit for each additional tank. It should further be understood that this system may be utilized with any type of compressed gas and any range of pressures making it useful in any industry that uses compressed gas.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. A system comprising:
a first gas tank and a second gas tank, each of said gas tanks having a fluid outlet;
a first regulator having an inlet and an outlet, the first regulator inlet being coupled to the outlet of the second gas tank and the first regulator outlet being coupled to the outlet of the first gas tank and the beverage dispensing system; and
a first check valve disposed between the output of the first regulator and output of the first gas tank.

2. The system of claim 1 wherein at least one regulator includes a pressure gauge.

3. The system of claim 1 wherein the first regulator and the first check valve are integrally formed.

4. The system of claim 1 further comprising:
an initiating apparatus coupled to the outlet of the first tank and the outlet of the first regulator; and
a calling apparatus in electronic communication with the initiating apparatus.

5. The system of claim 4 wherein the initiating apparatus includes a first high pressure switch in fluid communication with the output of the first tank and the outlet of the first regulator.

6. The system of claim 5 wherein the initialing apparatus further comprises a trigger coupled to the first high pressure switch, the trigger being in communication with the calling apparatus.

7. A system comprising:
at least two gas tanks, each of said gas tanks having a fluid outlet;
a selecting valve, the selecting valve having an inlet coupled to the outlet of the second gas tank and an output coupled to a beverage distributing system;
an initiating apparatus coupled to the selecting valve; and
a calling apparatus in electronic communication with the initiating apparatus.

8. The system of claim 7 wherein the calling apparatus further comprises a dialing apparatus.

9. The system of claim 7 wherein the selecting valve is a manual selecting valve.

10. The system of claim 7 wherein the selecting valve is an automatic selecting valve.

11. The system of claim 10 further comprising a pressure switch in electronic communication with the automatic selecting valve.

12. The system of claim 10 further comprising:
a third gas tank having a fluid outlet; and
an auxiliary selecting valve, the auxiliary selecting valve having an inlet coupled to the outlet of the third gas tank and an inlet coupled to the beverage distributing system.

13. The system of claim 12 wherein the auxiliary selecting valve has a normally closed configuration.

14. The system of claim 7 wherein the valve includes a second inlet coupled to the outlet of the first gas tank.

15. The system of claim 7 further comprising:
a third gas tank having a fluid outlet;
a second selecting valve, the second selecting valve having an inlet coupled to the outlet of the third gas tank and an outlet coupled to the beverage distributing system; and
a second initiating apparatus coupled to the outlet of the second gas tank.

16. A method comprising:
providing a system including at least two gas tanks, each of said gas tanks having a fluid outlet, at least one selecting valve having an inlet coupled to the outlet of the second gas tank and a output coupled to a beverage distributing system, an initiating apparatus coupled to the selecting valve, and a calling apparatus in electronic communication with the initiating apparatus;
sensing when the pressure of the gas leaving the first gas tank reaches a predetermined pressure; and
switching from the first gas tank to the second gas tank.
